(19) United States
(12) Patent Application Publication
(10) Pub. No.: US 2003/0212479 A1
(43) Pub. Date: Nov. 13, 2003

(54) Method for transferring individual data items to motor vehicles

(76) Inventors: Ahang Baghshomali, Lahnau (DE); Ulrich Rittner, Seevetal (DE); Joachim Troll, Pohlheim (DE)

Correspondence Address: BAKER BOTTS L.L.P., PATENT DEPARTMENT, 98 SAN JACINTO BLVD., SUITE 1500, AUSTIN, TX, 78701-4039, US

(21) Appl. No.: 10/397,585

(22) Filed: Mar. 26, 2003

Related U.S. Application Data
(63) Continuation of application No. PCT/DE01/03745, filed on Sep. 28, 2001.

(51) Int. Cl. G01C 22/00; G05D 1/00

(52) U.S. Cl. 701/24

(57) ABSTRACT

A method for transmitting data to an electronic component of a motor vehicle, in particular a navigation system is disclosed. According to the method, data is generated in a computer system that is external to the motor vehicle and is subsequently transmitted by said computer system to a short message service centre, for example via the Internet. The data is then polled by the service centre in a time-delayed manner and is transmitted via a mobile radio connection as an individual short message in short message service format to the navigation system of the motor vehicle.

### CROSS REFERENCE TO RELATED APPLICATION

This application is a continuation of copending International Application No. PCT/DE01/03745 filed Sep. 28, 2001, which designates the United States.

### BACKGROUND OF THE INVENTION

The invention relates to a method for transferring data to an electronic component of a motor vehicle.

The use of navigation systems in motor vehicles has become increasingly widespread in the last few years. These navigation systems determine a route from a location and a destination, continuously determine the current position of the vehicle and provide the driver of the vehicle with driving instructions to permit him to reach his destination. Such known navigation systems have an input unit by means of which, for example, the destination can be input. With these systems, one or more destinations are always input in the vehicle itself directly before the journey is begun. As the input unit does not have a keypad similar to a typewriter, the name of the destination is usually input by sequential selection of the letters presented on a display. In particular when a plurality of intermediate destinations are input, the inputting procedure becomes comparatively cumbersome and complex.

This applies in particular if further inputs in addition to the destination are to be made, for example the time at which individual destinations are to be reached.

U.S. Pat. No. 5,654,908 discloses that individual data items of a user are stored in an electronic notebook and this information is transmitted from the electronic notebook to a navigation system in a motor vehicle. The destination is defined by the navigation system by means of the information received. The data can be transferred here by means of radiowaves, a mobile telecommunications network or infrared radiation. When the data is transferred over a mobile telecommunications network, a portable telephone can be used. However, more details are not given on this.

DE 197 43 257 A1 discloses a data transmission method for transmitting data messages. The method is described by reference to the transmission of messages between traffic telematics devices which transmit data over what is referred to as a GSM/SMS air interface. GSM is the mobile phone standard which is customary in Europe. SMS refers to a short message service whose used data formats are defined in specification GSM-03. 40. Using the SMS it is possible to transmit any desired application data up to a length of 1120 bits over a point-to-point link. DE 197 43 257 A1 describes communication between a traffic telematics control center and any desired traffic telematics terminals, in particular with respect to what is referred to as the floating car data method. The transmission of individual data items of an individual user which can only be used by said user is not addressed in said document.

### SUMMARY OF THE INVENTION

The object of the present invention is to specify a method with which simplified conditioning of electronic devices in motor vehicles, in particular simplified data input, can be achieved, the data being individual data items which are not provided for a large number of users.

The object is achieved by means of a method for transferring data to an electronic component of a motor vehicle, the data being generated in a computer system arranged outside the motor vehicle, the data being transferred from the computer system to a service center for short messages and being transmitted with a time delay as an individual short message in the format of a short message service to the electric component of the motor vehicle over a mobile phone link when called by the service center.

The method according to the invention thus relates to purely individual data items to which only one user or a small number of users have access. With the method according to the invention, a car driver who is, for example, preparing for a business journey on the following day can select the respective destinations or other data on his home PC. To do this, the user can use, for example, a customary route planning program for PCs. The navigation-related data such as, for example, the destination or else the telephone number of a customer, the postcode or the precise address of the destination are subsequently transmitted onto the Internet as a short message, for example by means of a telephone fixed network connection and modem, and stored in a corresponding service center for short messages. On the next day, when the journey has begun the data is finally called with a time delay as an individual short message in the format of a short message service by the service center over a mobile phone link and transmitted to the electronic component of the motor vehicle, in particular a navigation system. The method according to the invention has the advantage that the route planning can take place before the actual journey begins and the data can be called at any time later as a short message. In companies, the route planning can, for example, also be performed by a central office which, for customer service vehicles, collates the customers to be visited on the next day and transfers this data as a short message to the service center. The data relating to the customers to be visited can then be interrogated directly the next morning by the driver of the customer service vehicle by means of a short message. As the transmission of short messages generally takes place comparatively slowly, when there is a direct transmission of the short message from the planning station into the motor vehicle undesired waiting times may occur under certain circumstances. These waiting times can be shortened by virtue of the fact that according to the invention the short messages are called by the service center.

In one particular embodiment there is provision that, after the electronic component is switched on, a mobile phone link is set up to the service center and the data is automatically transmitted from the service center to the electronic component. This automatic transmission and setting up of the mobile phone link can also be initiated here in particular by means of a specific operator control step on the electronic component, for example the pressing of a pushbutton key.

The method can be used for transmitting data for various electronic components in the motor vehicle so that, for example, setup settings or personalized data items such as the setting of a seat position or the like are transmitted. However, there is in particular provision that the electronic component is a navigation system and the data is data which is relevant to navigation. The data can also include in particular telephone numbers, postcodes or addresses here. Route planning is carried out in the navigation system by means of the transferred data. For the route planning, use is made in particular of digital map data which is carried along in the vehicle. The map data is stored, for example, on a CD ROM or a DVD in a known fashion per se. However, the route planning can also be carried out externally, for which purpose the necessary data such as the starting location and the destination are also transferred in a known fashion per se over a mobile phone link to a control center in which the route planning is carried out.

The short message service is in particular a short message service in a GSM mobile phone network, in particular an SMS message service. The data is transported here by means of what is referred to as a short message service center SMS-SC. The service center receives the short messages which are up to 160 characters long and passes them on to the receiver in the motor vehicle. The short messages are transmitted between the mobile station and service center using a transport protocol which is referred to as SM-DP. The further transporting of the short messages outside the GSM network to the SMS-SC can be carried out in various ways. More details on these methods which are known per se can be found, for example, in the book by Jörg Eberspächer and Hans-Jörg Vogel: GSM, Global System for Mobile Communication, BG Teubner Stuttgart 1997, pages 177 to 179.

A motor vehicle navigation system according to the invention having a central processing unit which is connected to an input unit and an output unit and to a mobile phone, it being possible to transmit data which is relevant to the vehicle navigation into a storage element of the navigation system by means of the mobile phone, is characterized in that the navigation system for automatically calling the data is configured as an individual message from a short message service center. In particular, a navigation system has means for converting the format of the short messages.

### BRIEF DESCRIPTION OF THE DRAWINGS

The invention will be explained in more detail below with reference to an exemplary embodiment and the drawing, in which:

FIG. 1 shows a flowchart,

FIG. 2 shows a block circuit diagram of the essential components.

### DETAILED DESCRIPTION OF THE PREFERRED EMBODIMENTS

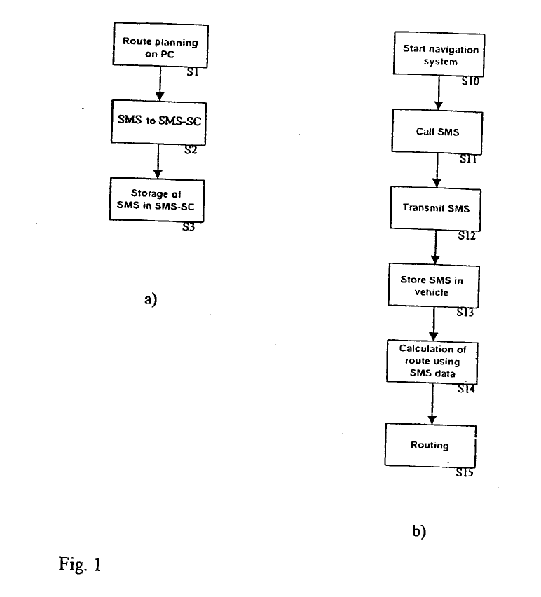

The method sequence will be explained in more detail with reference to FIG. 1. According to FIG. 1a, route planning is firstly performed by the user on his PC in step 51. Route planning programs which are known per se for personal computers can be used for this. In this route planning program, result data is produced which includes destinations in particular. Instead of the precise address of a destination, the data can include, for example, the geographic position of the destination, a telephone number or a postcode. A postcode is used here, for example, to define a specific town, while a telephone number defines a precise address with town, road and number of the building. The data generated is then transmitted as an SMS short message over the Internet to an SMS service center (52) by means of a modem. The SMS short message is stored in the SMS-5C. The first part of the method is thus terminated. If the user is now located in the vehicle, he can start the navigation system (step 510 in FIG. 1B). By actuating a corresponding calling knob, a mobile phone link is set up between the navigation system and the SMS-5C. Then, in step 511 the SMS is called by the navigation system and in step 512 it is transmitted from the SMS-5C to the navigation system. Finally, in step 513 the SMS is stored in the vehicle in a storage element of the navigation system. Then, the SMS data is converted into a format which can be further processed by the navigation system. For this purpose there is an appropriate software module in the navigation system. If the data is transmitted, for example, as telephone numbers, an assignment of a specific geographic position to the corresponding telephone number is made in the navigation system. Corresponding databases are present in the vehicle and are stored, for example, on a CD ROM or a DVD. Then, in step 512 the route calculation is carried out with the converted data. The route calculation is carried out here in a conventional way. In step S15, the routing information is then output to the driver until the driver has reached the destination.

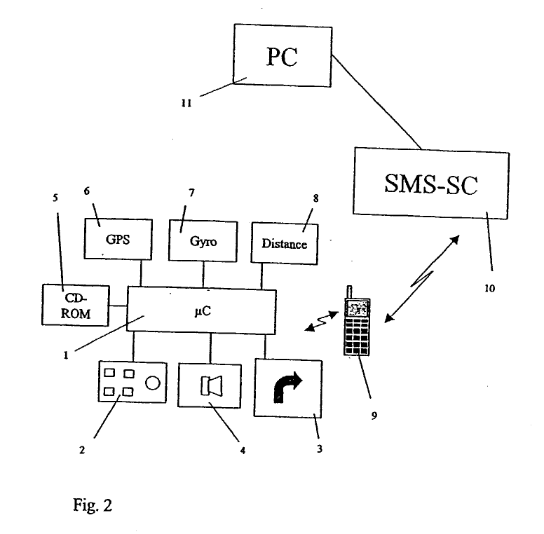

The essential components for carrying out the method are given by way of example in FIG. 2. The route planning is carried out on the PC 11 outside the vehicle. The data which is generated here is forwarded to the SMS-SC 10 over the Internet via a radio or fixed network connection. The navigation system whose central component is the processing unit 1 is located in the vehicle. An operator control unit 2 and a visual output unit 3 and an acoustic output unit 4 are connected to the processing unit 1. Settings of the navigation system can be made using the input unit 2. Routing information, for example in the form of arrow representations, are output using the visual output unit 3, while the routing instructions are output acoustically using the acoustic output unit 4. In order to carry out route planning, the navigation system in the vehicle has a storage element which is embodied by way of example as a CD-ROM 5 and is connected to the central processing unit 1. A route is calculated by reference to the starting locations and destinations using the map data of the CD-ROM 5 by a calculation module in the processing unit 1. The navigation system also has a GPS receiver unit 6 via which satellite signals which are used for determining positions are received. In order to be able to determine positions independently of satellites, the navigation system also has a directional sensor 7 and a distance sensor 8.

Furthermore, in the vehicle there is a mobile phone 9 which is connected to the navigation system. The connection between the navigation system and the mobile phone 9 may be a wire-bound or a wire-free connection.

In the case of a wire-free connection, a short-range radio link, in particular according to the Bluetooth method, is preferred. The transmission of data between the SMS-SC10 and the motor vehicle is made via a mobile phone link to the mobile phone 9.

The invention has been described by means of an exemplary embodiment, with modifications with respect to the navigation system used being readily possible.

1. A method for transferring data to an electronic component of a motor vehicle, comprising the steps:
generating the data in a computer system arranged outside the motor vehicle,
transferring the data from the computer system to a service center for short messages, and
transmitting the data with a time delay as an individual short message in the format of a short message service to the electronic component of the motor vehicle over a mobile phone link when called by the service center.

2. The method as claimed in claim 1, wherein, after the electronic component is switched on, a mobile phone link is set up to the service center and the data is automatically transmitted from the service center to the electronic component.

3. The method as claimed in claim 1, wherein the electronic component is a navigation system and the data is data which is relevant to navigation.

4. The method as claimed in claim 3, wherein route planning is carried out in the navigation system by means of the transmitted data.

5. The method as claimed in claim 4, wherein during the route planning digital map data which is carried along in the vehicle is accessed.

6. The method as claimed in claim 3, wherein the data includes information selected from the group consisting of telephone numbers, postcodes and addresses.

7. The method as claimed in claim 1, wherein the short message service is a short message service in a GMS mobile phone network.

8. The method as claimed in claim 7, wherein the short message service is an SMS message service.

9. The method as claimed in claim 1, wherein the data is generated in a personal computer.

10. The method as claimed in claim 1, wherein the data is transferred to the service center by the computer system via a fixed network telephone connection.

11. The method as claimed in claim 1, wherein individual data is additionally transmitted to the service center by the electronic component in the vehicle via the mobile phone link and can be called as individual data items by the service center by means of a computer system.

12. A motor vehicle navigation system comprising a central processing unit which is connected to an input unit and an output unit and to a mobile phone, for transmitting data which is relevant to the vehicle navigation into a storage element of the navigation system by means of the mobile phone, wherein the navigation system for automatically calling the data is configured as an individual short message from a short message service center.

13. The motor vehicle navigation system as claimed in claim 12, wherein the navigation system includes means for converting the format of the short message.

14. The motor vehicle navigation system as claimed in claim 12, wherein the navigation system also includes a nonvolatile and nonrewritable storage element, in particular a CD-ROM or a DVD, with digital map data.

15. The motor vehicle navigation system as in claim 12, wherein the mobile phone is coupled with the central processing unit through a wireless connection using Bluetooth method.

16. A motor vehicle navigation system comprising a central processing unit which is connected to an input unit and an output unit, a storage element and to a mobile phone, wherein the navigation system can automatically set up a call through the mobile phone and wherein the data is configured as an individual short message from a short message service center, and wherein data which is relevant to the vehicle navigation can be transmitted into the storage element of the navigation system by means of the mobile phone.

17. The motor vehicle navigation system as claimed in claim 16, wherein the navigation system includes means for converting the format of the short message.

18. The motor vehicle navigation system as claimed in claim 16, wherein the navigation system also includes a nonvolatile and nonrewritable storage element, in particular a CD-ROM or a DVD, with digital map data.

19. The motor vehicle navigation system as in claim 16, wherein the mobile phone is coupled with the central processing unit through a wireless connection using Bluetooth method.
